(19) United States
(12) Patent Application Publication
(10) Pub. No.: US 2026/0194247 A1
(43) Pub. Date: Jul. 9, 2026

(54) SMART MULTIFUNCTION AIR PURIFICATION AND VENTILATION

(71) Applicant: Nature's Cooling Solutions, Tucson, AZ (US)

(72) Inventors: George Wiese, Tucson, AZ (US); James Wiese, Vonore, TN (US)

(21) Appl. No.: 19/442,732

(22) Filed: Jan. 7, 2026

Related U.S. Application Data
(60) Provisional application No. 63/743,564, filed on Jan. 9, 2025.

(51) Int. Cl. F24F 11/00; B01D 46/00; B01D 46/44; B01D 46/46; B03C 3/36; F24F 7/003; F24F 7/06; F24F 110/12; F24F 110/22; F24F 110/52; F24F 110/64; F24F 110/65

(52) U.S. Cl. CPC F24F 11/0001; B01D 46/0043; B01D 46/0049; B01D 46/442; B01D 46/448; B01D 46/46; B03C 3/368; F24F 7/003; F24F 7/06; B01D 2273/30; B01D 2279/50; F24F 2011/0002; F24F 2110/12; F24F 2110/22; F24F 2110/52; F24F 2110/64; F24F 2110/65

(57) ABSTRACT

An air purification and ventilation system. The system includes an outdoor air monitor configured to measure one or more properties of an outdoor environment. The system further includes an indoor air monitor configured to measure one or more properties of an indoor environment. The system further includes a means for ventilating fluidly coupled to at least one outdoor air intake channel communicatively coupled to the outdoor air monitor and the indoor air monitor, configured to ventilate outside air to the indoor environment. The system further includes one or more air purification modules fluidly coupled to at least one indoor air intake channel communicatively coupled to the outdoor air monitor and the indoor air monitor, configured to purify air. The system further includes a plurality of motorized dampers communicatively coupled to the outdoor air monitor and the indoor air monitor, configured to move in position to direct airflow through the system.

### CROSS-REFERENCE TO RELATED APPLICATIONS

This application is a non-provisional and claims benefit of U.S. Provisional Application No. 63/743,564 filed Jan. 9, 2025, the specification of which is incorporated herein in their entirety by reference.

### FIELD OF THE INVENTION

The present invention is directed to an air system configured to selectively provide recirculating air purification and outside air dilution ventilation for the reduction of indoor air pollutants, as well as to provide outside air ventilation heating and ventilation cooling for thermal comfort and energy savings.

### BACKGROUND OF THE INVENTION

Consumers frequently encounter issues related to indoor air quality, including stale air, pet dander, smoke, Volatile Organic Compounds (VOCs), and carbon dioxide (CO₂) buildup, yet existing solutions often prove inadequate. Conventional air fresheners, while inexpensive, are generally regarded as detrimental to health and may exacerbate air quality problems by masking, rather than mitigating, indoor pollutants. Opening windows—an approach recommended by the Environmental Protection Agency (EPA) and the Centers for Disease Control and Prevention (CDC)—can improve ventilation but results in significant energy loss and exposes the indoor environment to outdoor temperature fluctuations and contaminants. Central system filters offer only intermittent relief and are ineffective in reducing CO2 or VOCs, while increasing energy consumption. Standalone recirculating air purifiers contribute to space clutter and likewise fail to address CO2 or some VOC concentrations. Heat Recovery Ventilators (HRVs) and Energy Recovery Ventilators (ERVs) provide limited volumes of dilution air and may be insufficient for timely removal of indoor pollutants.

Furthermore, when outdoor air quality is poor, continuous ventilation through HRVs or ERVs can introduce additional pollutants into the indoor space. Energy expenditures associated with such systems may range from approximately $200 to $800 annually. Heating and cooling account for nearly 50% of residential energy consumption which outside air ventilation can reduce by 10% to 40%. Although high-efficiency heating, ventilation, and air conditioning (HVAC) systems are available, their high cost has hindered widespread adoption. Accordingly, there exists a need for a cost-effective, high-efficiency HVAC system capable of delivering efficient heating and cooling while effectively mitigating indoor air pollutants, including particulate matter (PM), carbon dioxide (CO₂), and volatile organic compounds (VOCs). Ceiling fans provide a wind chill which reduces the energy needed to cool a space. Such systems provide wind chill only directly below the fan limiting effectiveness. They are unsightly, need cleaning and frequently are out of balance causing noise and other issues. There exists a need to provide a device that directs air toward room occupants and eliminates the other issues.

### BRIEF SUMMARY OF THE INVENTION

It is an objective of the present invention to provide systems that allow for an air purification system configured to provide efficient environmental control while managing particulates and toxic gas levels, as specified in the independent claims. Embodiments of the invention are given in the dependent claims. Embodiments of the present invention can be freely combined with each other if they are not mutually exclusive.

The present invention features a system and control that provides indoor air pollution mitigation, ventilation cooling, and ventilation heating. The system has two modes of pollution mitigation: outside air ventilation dilution and indoor air recirculation and purification. The control can be configured to use outside air mitigation during mild outside temperatures and switch to an indoor air purifier during temperature extremes. The control can further be configured to use outside air dilution to mitigate indoor air pollution when the outside air quality is healthy and to switch to an indoor air purifier when the outside air quality is unhealthy. The system has a control that automatically activates the ventilation cooling mode or the ventilation heating mode when free outside air can be used to increase indoor comfort and reduce the energy cost of air conditioning and mechanical heating.

The present invention features an air purification and ventilation system. The system may comprise an outdoor air monitor configured to measure one or more properties of an outdoor environment. The system may further comprise an indoor air monitor configured to measure one or more properties of an indoor environment. The system may further comprise a means for ventilating fluidly coupled to at least one outdoor air intake channel communicatively coupled to the outdoor air monitor and the indoor air monitor, configured to ventilate outside air to the indoor environment. The system may further comprise one or more air purification modules fluidly coupled to at least one indoor air intake channel communicatively coupled to the outdoor air monitor and the indoor air monitor, configured to purify air. The system may further comprise a plurality of motorized dampers communicatively coupled to the outdoor air monitor and the indoor air monitor, configured to move in position to direct airflow through the system. The present invention features multiple modes of air delivery to the indoor space. In one mode, users can direct the air toward the room occupants to provide wind chill. In another mode, the user can direct the air away from the occupant to provide winter air circulation.

One of the unique and inventive technical features of the present invention is the implementation of autonomous switching between multiple modes of airflow direction depending on the status of the interior and exterior environment, as determined by an air quality sensor placed indoors and another placed outdoors. Without wishing to limit the invention to any theory or mechanism, it is believed that the technical feature of the present invention advantageously provides for the present invention to mitigate the buildup of particulate and toxic gases while optimizing energy efficiency. None of the presently known prior references or work has the unique inventive technical feature of the present invention.

Furthermore, the inventive technical feature of the present invention is counterintuitive. The reason that it is counterintuitive is because it contributed to a surprising result. One of ordinary skill in the art would implement a single interior air monitor as well as non-motorized sealing and airflow channel components for autonomous air purification and ventilation to minimize the electrical and processing load for the device, thus resulting in the lowest risk of error. The present invention instead implements an indoor air quality monitor and an outdoor air quality monitor, the outputs of which are processed and compared to determine a configuration of a motorized damper. Surprisingly, this allows for the present invention to minimize the number of air flow paths while maximizing the efficiency of ventilation and purification. Thus, the inventive technical feature of the present invention contributed to a surprising result.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows an embodiment of the air purification, ventilation, and recirculation system of the present invention in a ventilating configuration.

FIG. 1B shows an embodiment of the air purification, ventilation, and recirculation system of the present invention in a purifying configuration.

FIG. 2A shows an embodiment of the air purification and ventilation system in a ducted configuration.

FIG. 2B shows a diagram of a bladeless ceiling diffuser embodiment of the present invention.

FIG. 2C shows an alternate diagram of the bladeless ceiling diffuser embodiment of the present invention, showing the internal mechanism of the device.

### DETAILED DESCRIPTION OF THE INVENTION

Following is a list of elements corresponding to a particular element referred to herein:
100 outdoor air monitor
200 indoor air monitor
300 means for ventilating
310 outside air intake channel
320 indoor air motorized damper
325 inside air intake channel
330 fan
350 air channel to inside
360 air channel to outside
370 air channel exhaust
400 air purification module
500 bladeless ceiling fan
510 housing
520 downward-facing diffuser
530 side-facing diffuser
540 diffuser motorized damper
550 ceiling
560 air channel to bladeless ceiling fan diffuser
600 ducted system
700 outside air motorized dampers
1000 air purification/ventilation system

The term “toxic gas” is defined herein as any gas and/or vapor that may cause discomfort or harm to living beings at a certain amount over a period of time.

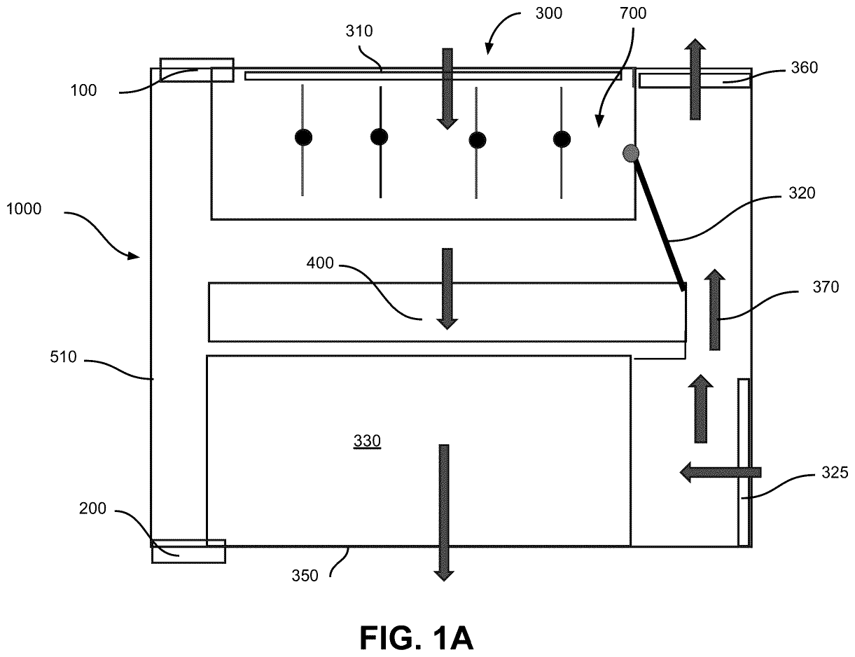

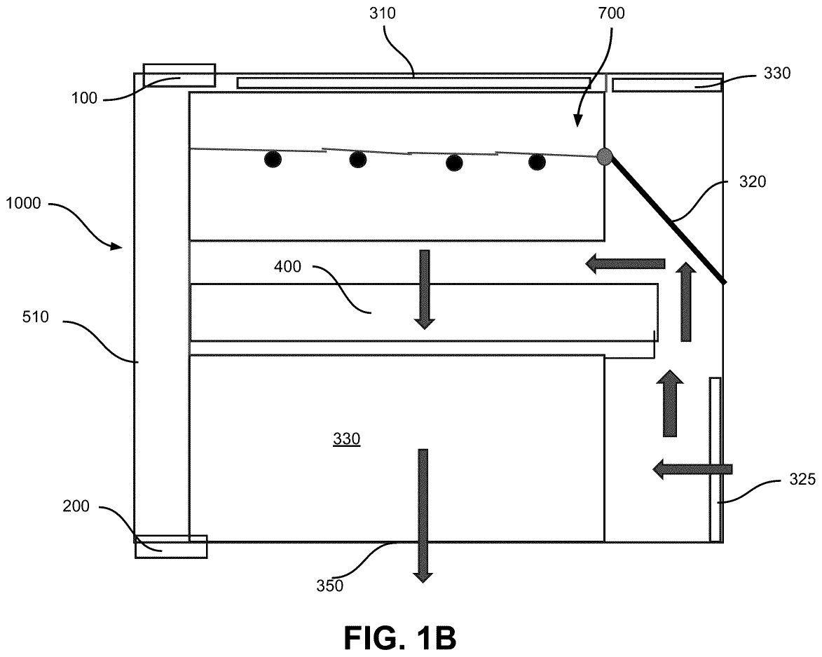

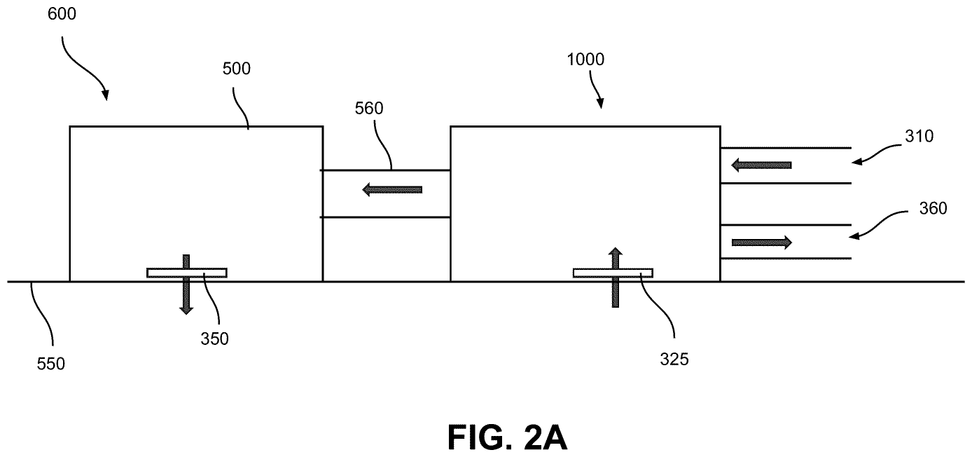

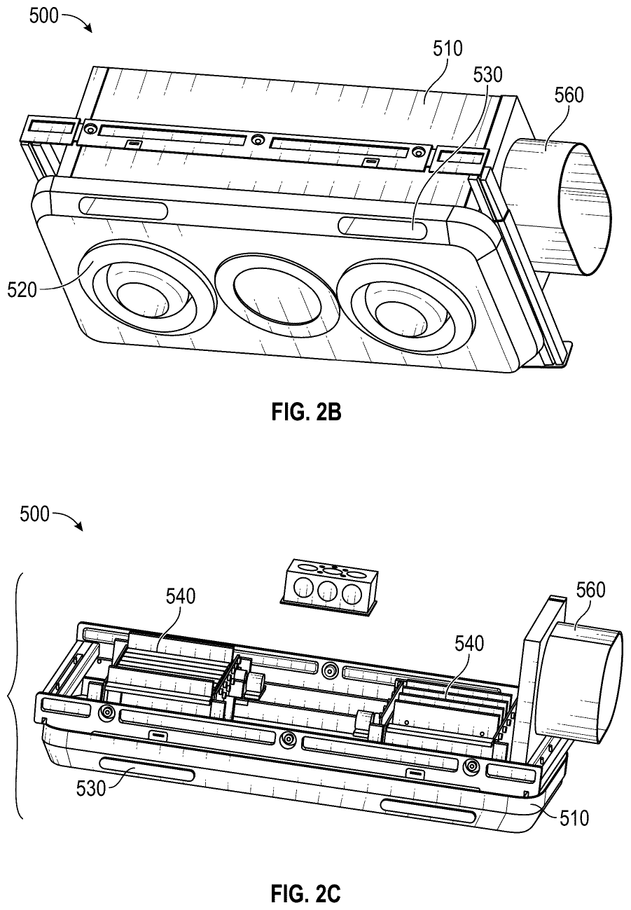

Referring now to FIGS. 1A-2C, the present invention features an air purification and ventilation system (1000). In some embodiments, the system (1000) may comprise an outdoor air monitor (100) configured to measure one or more properties of an outdoor environment and determine whether or not all properties of the outdoor environment are optimal for adjusting at least one property of one or more properties of the indoor environment, or can be mitigated by one or more air purification modules (400). The system may further be in communication with a weather service or an outside air quality service. The system (1000) may further comprise an indoor air monitor (200) configured to measure one or more properties of an indoor environment. The system (1000) may further comprise a means for ventilating (300) communicatively coupled to the outdoor air monitor (100) and the indoor air monitor (200), configured to ventilate outside air to the indoor environment. The system (1000) may further comprise one or more air purification modules (400) fluidly coupled to the means for ventilating (300), configured to purify air.

When the outdoor air monitor (100) determines all properties of the outdoor environment are optimal for adjusting at least one property of the one or more properties of the indoor environment, the means for ventilating (300) may be activated such that the at least one property of the one or more properties of the indoor environment reaches an optimal value. When the at least one property of the one or more properties of the indoor environment reaches the optimal value, the means for ventilating (300) may be deactivated. When the indoor air monitor (200) detects a level of particulates exceeding a particulate threshold, the means for ventilation (300), the one or more air purification modules (400), or a combination thereof may be activated. When the indoor air monitor (200) detects that the level of particulates is reduced below a particulate threshold, the means for ventilation (300), the one or more air purification modules (400), or the combination thereof may be deactivated. When the indoor air monitor (200) detects a level of toxic gas exceeding a gas threshold, the means for ventilation (300), the one or more air purification modules (400), or the combination thereof may be activated. When the indoor air monitor (200) detects that the level of toxic gas is reduced below a gas threshold, the means for ventilation (300), the one or more air purification modules (400), or the combination thereof may be deactivated.

In some embodiments, the particulate threshold, the gas threshold, or a combination thereof may be set by the user. In some embodiments, the particulate threshold, the high gas threshold, the low gas threshold, or a combination thereof may be automatically set. In some embodiments, the one or more properties of the outdoor environment and the one or more properties of the indoor environment may comprise a temperature measurement, a humidity measurement, an amount of particulates, an amount of toxic gas, or a combination thereof.

In some embodiments, the outdoor air monitor (100) may comprise a temperature sensor, a humidity sensor, an air quality sensor, an air quality service, a weather service, or a combination thereof. In some embodiments, the sensor(s) implemented into the outdoor air monitor (100) may comprise physical sensor(s) located proximate to the system (1000) in the outdoor environment, transmitting output data to the system (1000) through a wired and/or short-range wireless connection (e.g., Bluetooth Low Energy (BLE)). In some embodiments, the sensor(s) implemented into the outdoor air monitor (100) may comprise sensor(s) disposed somewhere in the outdoor environment within a range of the system (1000) such that the sensor(s) transmit output data to the system (1000) through a long-range wireless connection (e.g., LoRa, WiFi). The outdoor air monitor (100) may comprise any combination of these sensor configurations. In some embodiments, the outdoor air monitor (100) may comprise a single sensor for each given sensor type. In some embodiments, multiple instances of a sensor type may be implemented such that the outputs of corresponding sensor types are compared and combined (i.e., by an average) into a single output value. To allow for communication with the components of the system (1000), the outdoor air monitor (100) may comprise a processor configured to execute computer-readable instructions, a memory component operatively coupled to the processor, comprising computer-readable instructions for transmitting raw sensor data, and a communication component (e.g., a wired connection, a wireless transceiver, etc.) configured to allow for transmission of the sensor data. In some embodiments, the computer-readable instructions may further comprise pre-processing the raw sensor data into a more usable format, such as a waveform, a single value, etc.

In some embodiments, the indoor air monitor (200) may comprise a temperature sensor, a humidity sensor, an air quality sensor, or a combination thereof. In some embodiments, the indoor air monitor (200) may comprise sensor(s) disposed in the same room as the system (1000) such that the sensor(s) transmit data to the system (1000) over a wired and/or short-range wireless connection (e.g., Bluetooth Low Energy (BLE)). In some embodiments, the indoor air monitor (200) may comprise sensor(s) disposed throughout the building in which the system (1000) is disposed such that the sensor(s) transmit data to the system (1000) over a wired and/or short-range wireless and/or long-range wireless connection (e.g., LoRa, WiFi). The indoor air monitor (200) may comprise any combination of these sensor configurations. In some embodiments, the indoor air monitor (200) may comprise a single sensor for each given sensor type. In some embodiments, multiple instances of a sensor type may be implemented such that the outputs of corresponding sensor types are compared and combined (i.e., by an average) into a single output value. To allow for communication with the components of the system (1000), the indoor air monitor (200) may comprise a processor configured to execute computer-readable instructions, a memory component operatively coupled to the processor, comprising computer-readable instructions for transmitting raw sensor data, and a communication component (e.g., a wired connection, a wireless transceiver, etc.) configured to allow for transmission of the sensor data. In some embodiments, the computer-readable instructions may further comprise pre-processing the raw sensor data into a more usable format, such as a waveform, a single value, etc.

In some embodiments, the means for ventilating (300) may comprise at least one outside air intake channel (310), at least one outside air motorized damper (700) configured to allow airflow from the outdoor environment to the indoor environment, at least one inside air intake channel (325), and at least one indoor air motorized damper (320) configured to allow airflow from the indoor environment to the outdoor environment, and at least one fan (330) configured to direct air through the at least one air channel to inside (350). The air channels coupled to the means for ventilation (300) may be configured to maximize the flow of air from the indoor environment to the outdoor environment, and from the outdoor environment to the indoor environment.

In some embodiments, the air purification module (400) may comprise one or more filters, one or more ionizers, one or more UV lights, one or more other air purification methods, a stand-alone indoor air purifier, or a combination thereof. In some embodiments, the level of particulates may be indicative of an amount of inorganic ions, organic compounds, elemental carbon, crustable materials or other pollutants or a combination thereof an amount of pet dander, smoke, dust, mold, pollen, biological contaminants, pesticides or a combination thereof. In some embodiments, the level of toxic gas may be indicative of an amount of carbon dioxide, carbon monoxide, smoke, volatile organic compounds or a combination thereof. The air channels coupled to the air purification module (400) may be configured to maximize the amount of time that the air from the indoor environment is in contact with the air purification module (400), thus maximizing the filtering of particulates, toxic gas, etc.

The present invention features an air purification/ventilation system (1000). In some embodiments, the system (1000) may comprise an outdoor air monitor (100) configured to measure one or more properties of an outdoor environment and determine whether or not all properties of the outdoor environment are optimal for adjusting at least one property of one or more properties of the indoor environment, or can be mitigated by one or more air purification modules (400). The system may further be in communication with a weather service or an outside air quality service. The system (1000) may further comprise an indoor air monitor (200) configured to measure one or more properties of an indoor environment. The system (1000) may further comprise at least one inside air intake channel (325), at least one inside air motorized damper (320) configured to allow airflow from the indoor environment to the indoor environment. The system (1000) may further comprise at least one fan (330) communicatively coupled to the outdoor air monitor (100) and the indoor air monitor (200), configured to direct air through the at least one inside air intake channel (325). The system (1000) may further comprise one or more air purification modules (400) fluidly coupled to the at least one inside air intake channel (325), configured to purify air.

When the outdoor air monitor (100) determines all properties of the outdoor environment are optimal for adjusting at least one property of the one or more properties of the indoor environment, the at least one fan (330) may be activated, and one outside air damper (700) may be activated to direct air from the outdoor environment to the indoor environment, the at least one indoor motorized air damper (320) may be activated to direct air from the indoor environment to the outdoor environment such that the at least one property of the one or more properties of the indoor environment reaches an optimal value.

When the at least one property of the one or more properties of the indoor environment reaches the optimal value, the at least one fan (330), one outside air damper (700) and one indoor air motorized damper (320) may be deactivated. When the indoor air monitor (200) detects a level of particulates exceeding a particulate threshold, the at least one fan (330) may be activated, the at least one outside dampers (700) may be activated to direct air from the outside environment to the indoor environment, the at least one indoor air motorized damper (320) may be activated to direct air from the indoor environment, to the outdoor environment, or a combination thereof.

When the indoor air monitor (200) detects that the level of particulates is reduced below a low particulate threshold, the at least one fan (330), the at least one outside air damper (700) and the at least one indoor air motorized damper (320) may be deactivated. When the indoor air monitor (200) detects a level of toxic gas exceeding a gas threshold, the at least one fan (330), the at least one outside air damper (700) may be activated to direct air from the outdoor environment to the indoor environment and the at least one indoor air motorized dampers (320) may be activated to direct air from the indoor environment to the outside environment. When the indoor air monitor (200) detects that the level of toxic gas is reduced below a gas threshold, the at least one fan (330), at least one motorized outside damper (700) and the at least one indoor air motorized damper (320) may be deactivated.

When the indoor air monitor (200) detects a particulate level above the particulate threshold and the outside air monitor (100) detects that one or more properties of the outside air are not at an optimal level the at least one fan (330) may be activated to direct air from the inside environment through the air purification module (400) and to the inside environment.

When the indoor air monitor (200) detects a toxic gas level above the particulate threshold and the outside air monitor (100) detects that one or more properties of the outside air are not at an optimal level the at least one fan (330) may be activated to direct air from the inside environment through the air purification module (400) and to the inside environment.

In some embodiments, the particulate threshold, the gas threshold, or a combination thereof may be set by the user. In some embodiments, the particulate threshold, the gas threshold, or a combination thereof may be automatically set. In some embodiments, the one or more properties of the outdoor environment and the one or more properties of the indoor environment may comprise a temperature measurement, a humidity measurement, an amount of particulates, an amount of toxic gas, or a combination thereof.

The system of the present invention may be configured to switch back and forth between a ventilation mode and a purification mode through the use of one or more motorized dampers, communicatively coupled to the outdoor air monitor (100) and the indoor air monitor (200), configured to shift in position to seal off certain air channels and activate others. When shifting into the ventilation mode, the motorized damper(s) may be configured to seal off a channel leading from the indoor environment to the air purification module (400) and allow for air flow through the air channel from the indoor environment (325), the air channel to the outside environment (360), the air channel from the outside environment (310), and the air channel into the indoor environment (350). When shifting into the purification mode, the motorized damper(s) may be configured to seal off an air channel leading to the outdoor environment (360) and an air channel leading from the outdoor environment (310), while allowing for air flow through the air channel from the indoor environment (325) and the air channel into the indoor environment (350).

In some embodiments, the outdoor air monitor (100) may comprise a temperature sensor, a humidity sensor, an air quality sensor, or a combination thereof. In some embodiments, the indoor air monitor (200) may comprise a temperature sensor, a humidity sensor, an air quality sensor, or a combination thereof. In some embodiments, the system (1000) may further comprise one or more filters, one or more ionizers, one or more other air purification methods, or a combination thereof. fluidly coupled to the at least one intake channel (310). In some embodiments, the level of particulates may be indicative of an amount of inorganic ions, organic compounds, elemental carbon, crustable materials or other pollutants or a combination thereof. In some embodiments, the level of toxic gas may be indicative of an amount of carbon dioxide, carbon monoxide, smoke, VOCs, or a combination thereof.

In some embodiments the outside air intake channel (310), the exhaust air channel to outside (360), the air channel to the inside (350) or a combination may be fluidly connected with a ducted system (600). In some embodiments the air channel to the inside (560) may be connected to a bladeless ceiling fan (500).

Referring now to FIGS. 2A-2B, the present invention features a bladeless ceiling fan device (500). In some embodiments, the device (500) may comprise a housing (510) comprising a downward face and a plurality of side faces, fluidly coupled to an air channel to the diffuser (560). The ducting system may comprise one or more indoor air intake channels (325) fluidly coupled to an indoor environment, configured to accept air from the indoor environment. The ducting system (600) may further comprise one or more exhaust air channels to outside (360) fluidly coupled to an outdoor environment and the one or more indoor air intake channels (325), configured to direct air to the outdoor environment. The ducting system (600) may further comprise one or more outdoor air intake channels (310) fluidly coupled to the outdoor environment, configured to direct air from the outdoor environment to the indoor environment.

The device (500) may further comprise a plurality of diffusers. The plurality of diffusers may comprise one or more downward-facing jet diffusers (520) disposed on the downward face of the housing (510), fluidly coupled to the ducting system (600). The plurality of diffusers may further comprise a plurality of side-facing diffusers (530), each side-facing jet diffuser disposed on a side face of the plurality of side faces of the housing (510), fluidly coupled to the ducting system (600). The device (500) may further comprise a motorized damper (540) disposed within the housing, having a first mode and a second mode. In the first mode, the motorized damper (540) may be positioned such that air is directed through the ducting system (600) to the downward-facing jet diffusers. In the second mode, the motorized damper (540) may be positioned such that air is directed through the ducting system (600) to the side-facing diffusers.

The present invention features a comprehensive system that provides superior air cleaning (including CO2), even during extreme temperatures, wildfires, smog, and pandemics, while using 70% to 90% less energy than existing systems. In addition, the present invention provides carbon-free outdoor air ventilation to reduce the cost of heating and cooling homes by 20% to 40%. The present invention is specialized to deliver air directly to the rooms that the user inhabits most often.

The present invention is configured to treat different types of pollution with different mitigation solutions: continuous pollution that builds over time (stale air, VOC off-gassing, pet odors), and transient pollution (cooking, smoking, cleaning, CO2). Continuous pollution is handled by a daily room refresh comprising high-volume ventilation for a short duration at the optimum time of day. Transient pollution is handled by demand ventilation. Indoor air quality is monitored to track CO₂, Radon, VOCs, and Particulate Matter (PM) or a combination thereof to mitigate elevated pollution levels when they get too high. In some embodiments, ventilation may occur at the optimum time of day to overcool/overheat the indoor environment such that the target temperature is achieved later in the day. In some embodiments, the rate of ventilation from the outside environment to the inside environment may be determined based on the outside temperature, the indoor current temperature, the indoor target temperature, the humidity, or a combination thereof.

The daily room refresh is timed to minimize the energy impact from exhausting conditioned room air. A weather forecast or an algorithm predicts the daily temperature and the refresh is timed to ventilate when the difference between the outdoor temperature and the indoor temperature is at a minimum. If the outdoor air is too polluted, the air purifier mode is used to refresh the air. The duration of the refresh and the amount of air for the cycle may be input by the user or automatically calculated.

Determining the optimum time of day is done by tracking the outdoor air pollution levels with an internet service and/or by an outside air quality sensor and tracking the outdoor temperature and humidity with an outdoor thermometer/humidity meter and/or a weather service. When the air pollution is low outside, the outside air can be freely used to mitigate the indoor air and maintain a target indoor temperature and humidity. When the outside air is too hot, too cold, or too polluted with wildfire smoke, smog, or ozone, an air purifying function is used to recirculate and clean the indoor air. If high indoor CO2 levels are detected, outside air ventilation may be used.

The present invention may implement a plurality of air intakes disposed at different points on the building. At least one air intake may be disposed on the north side of the building and at least one air intake may be disposed on the south/west side of the building. The temperature may differ by 10 to 20 degrees F between these two intake zones, with the north side being cooler than the south/west side. The north side intake may be used for cooling (e.g. summer ventilation, summer cooling, ventilation for sunlit rooms). The south/west side intake may be used for heating (e.g. winter ventilation, winter heating).

In some embodiments, the present invention may implement ventilation heating. The system may automatically detect when the outside temperature is warmer than the inside air, most likely in the afternoon, and use this air for ventilation heating. This may be especially useful during the spring and fall when the climate is mild in the afternoon and able to move the indoor temperature toward the target temperature. In some embodiments, the system of the present invention may comprise a ventilation-purifier window platform. This platform may be a single-room solution that provides carbon-free cooling, heating, and healthy air. The platform may be disposed through a window of a room such that air is able to selectively flow from inside to outside, and outside to inside through the platform.

In some embodiments, the platform may comprise a ventilation inside exhaust and a ventilation outside exhaust, configured to allow airflow from the indoor environment through the ventilation inside exhaust to the outdoor environment through the ventilation outside exhaust. The platform may further comprise an air channel configured to allow airflow from the outdoor environment to the indoor environment. The platform may further comprise one or more air purification modules disposed in-line with the air channel, configured to filter the air flowing through the air channel for particulates, toxic gas, or a combination thereof. The platform may further comprise a one or more mode dampers having a first mode and a second mode, configured to direct the flow of air through the platform. In the first mode, the mode damper may allow ventilation of air from outside to inside through the air channel and from inside to outside through the ventilation inside exhaust and the ventilation outside exhaust. In the second mode, the mode damper may allow air to circulate through the ventilation inside exhaust to the air channel, through the one or more filters, and back to the indoor environment. In some embodiments, the mode damper(s) may be operatively coupled to a damper motor configured to switch the mode damper between modes upon actuation.

In some embodiments, the system of the present invention may comprise a bladeless ceiling fan platform. This platform may be disposed on a ceiling of a room and fluidly coupled to specialized ducting comprising one or more intakes. This platform may provide smart pollution mitigation, daily refresh, ventilation heating, ventilation cooling, and wind chill. In some embodiments, this platform may be used for ventilating high-use rooms. In some embodiments, this platform may comprise a plurality of outputs. The plurality of outputs may comprise one or more diffusers configured to direct airflow downwards. The one or more diffusers may comprise orbital jet diffusers configured to adjust to direct air wind chill toward occupants. The plurality of outputs may further comprise one or more side vents configured to direct airflow along the ceiling and the walls of the room. In some embodiments, this platform may further comprise a motorized damper for changing air direction. The motorized damper may be configured to direct air downward to the room for summer wind chill. The motorized damper may be further configured to direct air horizontally away for winter mixing. The motorized damper may be further configured to direct air to the room for wind chill upon user actuation.

In some embodiments, the platform may comprise one or more outside air intakes and one or more outside air sensors coupled to the one or more outside air intakes, configured to measure one or more outdoor environmental properties. The platform may further comprise sound-absorbing ducting fluidly coupled to the one or more outside air intakes. The platform may further comprise a jet diffuser fluidly coupled to the ducting and the indoor environment, configured to direct air from the one or more outside air intakes to the indoor environment. The platform may further comprise a fan box fluidly coupled to the ducting and the indoor environment, configured to direct air from the indoor environment, through the ducting to the outdoor environment through the one or more outside air intakes. The fan box may comprise an air purifier configured to filter the air of particulates, toxic gas, or a combination thereof. The platform may further comprise a remote-controlled indoor air sensor configured to measure one or more indoor environmental properties.

In some embodiments, the system of the present invention may comprise a heat pump configured for ventilation cooling and heating. In some embodiments, the heat pump may be disposed through a window such that air can flow selectively from the inside to the outside and from the outside to the inside through the heat pump. In other embodiments, the heat pump may be disposed through a wall of a room such that air can flow selectively from the inside to the outside and from the outside to the inside through the heat pump.

In some embodiments, the system of the present invention may comprise a software application communicatively coupled to the platform. The software application may be stored on a computing device and may comprise an interface that allows for user input. In some embodiments, the software application may be configured to set and/or adjust the target temperature, the target humidity, the particulate threshold, the toxic gas threshold, or a combination thereof. In some embodiments, the software application may set these target values/thresholds automatically, such as through a preprogrammed procedure installed into the computing device. In some embodiments, the software application may be configured to accept user input to set and/or adjust these target values/thresholds. In these embodiments, the computing device may comprise a user interface, such as a physical user interface (e.g., a plurality of buttons and displays on the system (1000)) or through a software application executed on a separate computing device communicatively coupled to the computing device of the system (1000) (e.g., a smartphone or a desktop computer wirelessly coupled to the system (1000)). In some embodiments, the software application may be further configured to trigger actuation of and determine a position/configuration of the plurality of motorized dampers (700). In some embodiments, the plurality of motorized dampers (700) may be controlled automatically. In some embodiments, the software application may be further configured to display the one or more outdoor environmental properties and/or the one or more indoor environmental properties. In some embodiments, the computing device may comprise and/or be communicatively coupled to one or more display components configured to display the one or more outdoor environmental properties and/or the one or more indoor environmental properties.

Referring now to FIGS. 1A-1B, the present invention features an air purification and ventilation system (1000). The system (1000) may comprise an outdoor air monitor (100) configured to measure one or more properties of an outdoor environment and determine whether or not all properties of the outdoor environment are optimal for adjusting at least one property of one or more properties of the indoor environment, or can be mitigated by one or more air purification modules (400). The system (1000) may further comprise an indoor air monitor (200) configured to measure one or more properties of an indoor environment. The system (1000) may further comprise a means for ventilating (300) fluidly coupled to at least one outdoor air intake channel (325, configured to ventilate outside air to the indoor environment. The system (1000) may further comprise one or more air purification modules (400) fluidly coupled to at least one indoor air intake channel (325), configured to purify air. The system (1000) may further comprise a plurality of motorized dampers (700) communicatively coupled to the outdoor air monitor (100) and the indoor air monitor (200), configured to move in position to direct airflow through the system (1000).

When the outdoor air monitor (100) determines all properties of the outdoor environment are optimal for adjusting at least one property of the one or more properties of the indoor environment, or can be mitigated by the air purifying module (400), the plurality of motorized damper components (700) may actuate to direct the airflow towards the means for ventilating (300) such that the at least one property of the one or more properties of the indoor environment reaches an optimal value. When the at least one property of the one or more properties of the indoor environment reaches the optimal value, the plurality of motorized dampers (700) may actuate to direct the airflow away from the means for ventilating (300). When the outdoor air monitor (100) detects that one or more properties of the outdoor environment are not optimal for adjusting at least one property of the one or more properties of the indoor environment and can not be mitigated by the one or more air purifying modules (400), the plurality of motorized dampers (700) may actuate such that the airflow is directed to the one or more air purification modules (400) such that the at least one property of the one or more properties of the indoor environment reaches an optimal value. When the at least one property of the one or more properties of the indoor environment reaches the optimal value, the plurality of motorized dampers (700) may actuate to direct the airflow away from the one or more air purification modules (400).

Referring again to FIGS. 1A-1B, the present invention features an air purification and ventilation system (1000). The system (1000) may comprise an outdoor air monitor (100) configured to measure one or more properties of an outdoor environment and determine whether or not all properties of the outdoor environment are optimal for adjusting at least one property of one or more properties of the indoor environment, or can be mitigated by one or more air purification modules (400). The system (1000) may further comprise an indoor air monitor (200) configured to measure one or more properties of an indoor environment. The system (1000) may further comprise at least one intake channel (310) configured to allow the airflow from the outdoor environment to the indoor environment. The system (1000) may further comprise at least one outdoor exhaust channel (370) configured to allow the airflow from the indoor environment to the outdoor environment. The system (1000) may further comprise at least one indoor intake channel (325) configured to allow the airflow from the indoor environment. The system (1000) may further comprise at least one indoor exhaust channel (350) configured to allow the airflow into the indoor environment. The system (1000) may further comprise at least one fan (330) communicatively coupled to the outdoor air monitor (100) and the indoor air monitor (200), configured to direct air through the at least one intake channel (310) and the at least one outdoor exhaust channel (370). The system (1000) may further comprise one or more air purification modules (400) fluidly coupled to the at least one indoor intake channel (325) and the at least one indoor exhaust channel (325), configured to purify air. The system (1000) may further comprise a plurality of motorized dampers (700) communicatively coupled to the outdoor air monitor (100) and the indoor air monitor (200), configured to move in position to direct the airflow through the system (1000).

When the outdoor air monitor (100) determines one or more properties of the outdoor environment are optimal for adjusting at least one property of the one or more properties of the indoor environment, or can be mitigated by the air purification module (400), the at least one fan (330) and the plurality of motorized dampers (700) may activate to direct the airflow through the at least one indoor intake channel (325), the at least one outdoor exhaust channel (370), the at least one intake channel (310), and the at least one indoor exhaust channel (350) such that the at least one property of the one or more properties of the indoor environment reaches an optimal value. When the at least one property of the one or more properties of the indoor environment reaches the optimal value, the at least one fan (330) may deactivate and the plurality of motorized dampers (700) may actuate to direct the airflow away from the at least one exhaust channel (370). When the indoor air monitor (200) detects a level of particulates exceeding a particulate threshold, the at least one fan (330) and the plurality of motorized dampers (700) may activate to direct the airflow through the at least one indoor intake channel (325), the one or more air purification module (400), and the at least one indoor exhaust channel (350). When the indoor air monitor (200) detects that the level of particulates is reduced below a particulate threshold, the at least one fan (330) may deactivate and the plurality of motorized dampers (700) may actuate to direct the airflow away from the one or more air purification modules (400). When the indoor air monitor (200) detects a level of toxic gas exceeding a gas threshold, the at least one fan (330) and the plurality of motorized dampers (700) may activate to direct the airflow through the at least one indoor intake channel (325) and the at least one outdoor exhaust channel (370). When the indoor air monitor (200) detects that the level of toxic gas is reduced below a gas threshold, the at least one fan (330) may deactivate and the plurality of motorized dampers (700) are actuated to direct the airflow away from the one or more purification modules (400).

Referring now to FIG. 2A, the present invention features a ducted air system (600). The ducted air system (600) may comprise one or more indoor air intake channels (325) fluidly coupled to an indoor environment, configured to accept air from the indoor environment. The ducted air system (600) may further comprise one or more outdoor exhaust channels (320) fluidly coupled to an outdoor environment and the one or more indoor air intake channels (325), configured to direct air to the outdoor environment. The ducted air system (600) may further comprise one or more outdoor air intake channels (310) fluidly coupled to the outdoor environment, configured to direct air from the outdoor environment to the indoor environment. The ducted air system (600) may further comprise an air purification and ventilation system (1000), fluidly coupled to an indoor environment by the one or more indoor air intake channels (325) and an outdoor environment by the one or more outdoor exhaust channels (320) and the one or more outdoor air intake channels (310). The air purification and ventilation system (1000) may comprise an indoor air monitor (100) configured to measure one or more properties of the indoor environment, an outdoor air monitor (200) configured to measure one or more properties of the outdoor environment, and a plurality of motorized dampers (700) configured to direct airflow through the system to ventilate or purify the air from the indoor environment depending on the one or more properties of the indoor environment and the one or more properties of the outdoor environment. The air purification and ventilation system (1000) in this embodiment may comprise any combination of components described above as components of the air purification and ventilation system (1000) of the present invention.

The ducted air system (600) may further comprise a bladeless ceiling fan device (500) coupled to the air purification and ventilation system (1000) by an air channel (560). The bladeless ceiling fan device (500) may comprise a housing (510) comprising a downward face and a plurality of side faces. The bladeless ceiling fan device (500) may further comprise a plurality of diffusers. The plurality of diffusers may comprise one or more downward-facing jet diffusers (520) disposed on the downward face of the housing (510), fluidly coupled to the one or more indoor air intake channels (325), the one or more outdoor exhaust channels (320), and the one or more outdoor air intake channels (310). The plurality of diffusers may further comprise a plurality of side-facing diffusers (530), each side-facing diffuser disposed on a side face of the plurality of side faces of the housing (510), fluidly coupled to the one or more indoor air intake channels (325), the one or more outdoor exhaust channels (320), and the one or more outdoor air intake channels (310).

The bladeless ceiling fan device (500) may further comprise a motorized damper (540) disposed within the housing, having a first mode and a second mode. In the first mode, the motorized damper (540) may be positioned such that air is directed through the ducting system (600) from the outdoor environment to the indoor environment through the one or more downward-facing jet diffusers (520). In the second mode, the motorized damper (540) may be positioned such that air is directed through the ducting system (600) from the outdoor environment to the indoor environment through the side-facing diffusers.

In some embodiments, the bladeless ceiling fan device (500) may be coupled to the ducting system (600) comprising the one or more indoor air intake channels (325), the one or more outdoor exhaust channels (320), and the one or more outdoor intake channels (310) through the air purification and ventilation system (1000). In some embodiments, the bladeless ceiling fan device (500) may be coupled to the ducting system (600) comprising the one or more indoor air intake channels (325), the one or more outdoor exhaust channels (320), and the one or more outdoor intake channels (310) directly.

In some embodiments, determining, by the outdoor air monitor (100), whether or not all properties of the outdoor environment are optimal for adjusting at least one property of the one or more properties of the indoor environment, or can be mitigated by the one or more air purification modules (400) may comprise determining an optimal time of day at which all properties of the outdoor environment are optimal for adjusting at least one property of the one or more properties of the indoor environment, or can be mitigated by the one or more air purification modules (400). The ventilation systems may activate at this optimal time of day.

The computer system can include a desktop computer, a workstation computer, a laptop computer, a netbook computer, a tablet, a handheld computer (including a smartphone), a server, a supercomputer, a wearable computer (including a SmartWatch^{TM}), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C #, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft® .NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1) An air purification and ventilation system (1000) comprising:
a) an outdoor air monitor (100) configured to measure one or more properties of an outdoor environment and determine whether or not all properties of the outdoor environment are optimal for adjusting at least one property of one or more properties of the indoor environment, or can be mitigated by one or more air purification modules (400);
b) an indoor air monitor (200) configured to measure the one or more properties of an indoor environment;
c) a means for ventilating (300) fluidly coupled to at least one outdoor air intake channel (310), configured to ventilate outside air to the indoor environment;
d) the one or more air purification modules (400) fluidly coupled to at least one indoor air intake channel (325), configured to purify air; and
e) a plurality of motorized dampers (700) communicatively coupled to the outdoor air monitor (100) and the indoor air monitor (200), configured to move in position to direct airflow through the system (1000);
wherein, when the outdoor air monitor (100) determines all properties of the outdoor environment are optimal for adjusting at least one property of the one or more properties of the indoor environment, or can be mitigated by the one or more air purification modules (400), the plurality of motorized damper components (700) actuate to direct the airflow towards the means for ventilating (300) such that the at least one property of the one or more properties of the indoor environment reaches an optimal value;
wherein, when the at least one property of the one or more properties of the indoor environment reaches the optimal value, the plurality of motorized dampers (700) actuate to direct the airflow away from the means for ventilating (300);
wherein, when the outdoor air monitor (100) detects that one or more properties of the outdoor environment are not optimal for adjusting at least one property of the one or more properties of the indoor environment and can not be mitigated by the one or more air purifying modules (400), the plurality of motorized dampers (700) actuate such that the indoor airflow is directed to the one or more air purification modules (400) such that the at least one property of the one or more properties of the indoor environment reaches an optimal value;
wherein, when the at least one property of the one or more properties of the indoor environment reaches the optimal value, the plurality of motorized dampers (700) actuate to direct the airflow away from the one or more air purification modules (400).

2. The system (1000) of claim 1, wherein the particulate threshold, the gas threshold, or a combination thereof are automatically set, set by the user, or a combination thereof.

3. The system (1000) of claim 1, wherein the one or more properties of the outdoor environment and the one or more properties of the indoor environment comprise a temperature measurement, a humidity measurement, an amount of particulates, an amount of toxic gas, or a combination thereof.

4. The system (1000) of claim 1, wherein the outdoor air monitor (100) comprises a temperature sensor, a humidity sensor, one or more air quality sensors, an outdoor air quality service, or a combination thereof.

5. The system (1000) of claim 4, wherein at least a portion of the one or more properties of the outdoor environment are communicated from the outdoor air quality service, a weather forecast service, or a combination thereof.

6. The system (1000) of claim 1, wherein the indoor air monitor (200) comprises a temperature sensor, a humidity sensor, one or more air quality sensors, or a combination thereof.

7. The system (1000) of claim 1, wherein the means for ventilating (300) comprises at least one intake channel (310) configured to allow airflow from the outdoor environment to the indoor environment, at least one exhaust channel (370) configured to allow airflow from the indoor environment to the outdoor environment, and at least one fan (330) configured to direct air through the at least one intake channel (310), or a combination thereof.

8. The system (1000) of claim 1, wherein the one or more air purification modules (400) comprise one or more filters, one or more ionizers, one or more other air purification methods or a combination thereof and at least one fan (330) configured to direct air through the at least one intake channel (320).

9. The system (1000) of claim 1, wherein the level of particulates may be indicative of an amount of inorganic ions, organic compounds, elemental carbon, crustable materials or other pollutants or a combination thereof.

10. The system (1000) of claim 1, wherein the determining, by the outdoor air monitor (100), whether or not all properties of the outdoor environment are optimal for adjusting at least one property of the one or more properties of the indoor environment, or can be mitigated by the one or more air purification modules (400) comprises determining an optimal time of day at which all properties of the outdoor environment are optimal for adjusting at least one property of the one or more properties of the indoor environment, or can be mitigated by the one or more air purification modules (400).

11. An air purification and ventilation system (1000) comprising:
a) an outdoor air monitor (100) configured to measure one or more properties of an outdoor environment and determine whether or not all properties of the outdoor environment are optimal for adjusting at least one property of one or more properties of the indoor environment, or can be mitigated by one or more air purification modules (400);
b) an indoor air monitor (200) configured to measure the one or more properties of an indoor environment;
c) at least one intake channel (310) configured to allow the airflow from the outdoor environment to the indoor environment;
d) at least one outdoor exhaust channel (370) configured to allow the airflow from the indoor environment to the outdoor environment;
e) at least one indoor intake channel (325) configured to allow the airflow from the indoor environment;
f) at least one indoor exhaust channel (350) configured to allow the airflow into the indoor environment;
g) at least one fan (330) communicatively coupled to the outdoor air monitor (100) and the indoor air monitor (200), configured to direct air through the at least one intake channel (310) and the at least one outdoor exhaust channel (370);
h) the one or more air purification modules (400) fluidly coupled to the at least one indoor intake channel (325) and the at least one indoor exhaust channel (325), configured to purify air;
i) a plurality of motorized dampers (700) communicatively coupled to the outdoor air monitor (100) and the indoor air monitor (200), configured to move in position to direct the airflow through the system (1000);
wherein, when the outdoor air monitor (100) determines all properties of the outdoor environment are optimal for adjusting at least one property of the one or more properties of the indoor environment, or can be mitigated by the one or more air purification modules (400), the at least one fan (330) and the plurality of motorized dampers (700) activates to direct the airflow through the at least one indoor intake channel (325), the at least one outdoor exhaust channel (370), the at least one intake channel (310), and the at least one indoor exhaust channel (350) such that the at least one property of the one or more properties of the indoor environment reaches an optimal value;
wherein, when the at least one property of the one or more properties of the indoor environment reaches the optimal value, the at least one fan (330) deactivates and the plurality of motorized dampers (700) actuate to direct the airflow away from the at least one exhaust channel (370);
wherein, when the indoor air monitor (200) detects a level of particulates exceeding a particulate threshold, the at least one fan (330) and the plurality of motorized dampers (700) activate to direct the airflow through the at least one indoor intake channel (325), the one or more air purification module (400), and the at least one indoor exhaust channel (350);
wherein, when the indoor air monitor (200) detects that the level of particulates is reduced below a particulate threshold, the at least one fan (330) deactivates and the plurality of motorized dampers (700) actuate to direct the airflow away from the one or more air purification modules (400);
wherein, when the indoor air monitor (200) detects a level of toxic gas exceeding a gas threshold, the at least one fan (330) and the plurality of motorized dampers (700) activate to direct the airflow through the at least one indoor intake channel (325) and the at least one outdoor exhaust channel (370); and
wherein, when the indoor air monitor (200) detects that the level of toxic gas is reduced below a gas threshold, the at least one fan (330) deactivates and the plurality of motorized dampers (700) are actuated to direct the airflow away from the one or more purification modules (400).

12. The system (1000) of claim 11, wherein the particulate threshold, the gas threshold, or a combination thereof are set by the user.

13. The system (1000) of claim 11, wherein the particulate threshold, the gas threshold, or a combination thereof are automatically set.

14. The system (1000) of claim 11, wherein the one or more properties of the outdoor environment and the one or more properties of the indoor environment comprise a temperature measurement, a humidity measurement, an amount of particulates, an amount of toxic gas, or a combination thereof.

15. The system (1000) of claim 11, wherein the outdoor air monitor (100) comprises a temperature sensor, a humidity sensor, one or more air quality sensors, an outdoor air quality service, a weather service or a combination thereof.

16. The system (1000) of claim 11, wherein the indoor air monitor (200) comprises a temperature sensor, a humidity sensor, an air quality sensor, or a combination thereof.

17. The system (1000) of claim 11 further comprising one or more air purification modules (400) fluidly coupled to the at least one intake channel (310).

18. The system (1000) of claim 11, wherein the level of particulates is indicative of an amount of inorganic ions, organic compounds, elemental carbon, crustable materials or other pollutants or a combination thereof.

19. The system (1000) of claim 11, wherein the determining, by the outdoor air monitor (100), whether or not all properties of the outdoor environment are optimal for adjusting at least one property of the one or more properties of the indoor environment, or can be mitigated by the one or more air purification modules (400) comprises determining an optimal time of day at which all properties of the outdoor environment are optimal for adjusting at least one property of the one or more properties of the indoor environment, or can be mitigated by the one or more air purification modules (400).

20. A ducted air system (600) comprising:
a) one or more indoor air intake channels (325) fluidly coupled to an
indoor environment, configured to accept air from the indoor environment;
b) one or more outdoor exhaust channels (360) fluidly coupled to an outdoor environment and the one or more indoor air intake channels (310), configured to direct air to the outdoor environment;
c) one or more outdoor air intake channels (310) fluidly coupled to the outdoor environment, configured to direct air from the outdoor environment to the indoor environment;
d) an air purification and ventilation system (1000), fluidly coupled to an indoor environment by the one or more indoor air intake channels (325) and an outdoor environment by the one or more outdoor exhaust channels (360) and the one or more outdoor air intake channels (310), comprising an indoor air monitor (100) configured to measure one or more properties of the indoor environment, an outdoor air monitor (200) configured to measure one or more properties of the outdoor environment, and a plurality of motorized dampers (700) configured to direct airflow through the system to ventilate or purify the air from the indoor environment depending on the one or more properties of the indoor environment and the one or more properties of the outdoor environment; and
e) a bladeless ceiling fan device (500) coupled to the air purification and ventilation system (1000) by an air channel (560), the bladeless ceiling fan device (500) comprising:
i) a housing (510) comprising a downward face and a plurality of side faces;
ii) a plurality of diffusers comprising:
A) one or more downward-facing jet diffusers (520) disposed on the downward face of the housing (510), fluidly coupled to the one or more indoor air intake channels (325) the one or more outdoor exhaust channels (320), and the one or more outdoor air intake channels (310); and
B) a plurality of side-facing diffusers (530), each side-facing diffuser disposed on a side face of the plurality of side faces of the housing (510), fluidly coupled to the one or more indoor air intake channels (325), and the one or more outdoor air intake channels (310); and
iii) a motorized damper (540) disposed within the housing, having a first mode and a second mode;
wherein, in the first mode, the motorized damper (540) is positioned such that air is directed through the ducting system (600) from the outdoor environment to the indoor environment through the one or more downward-facing jet diffusers (520);
wherein, in the second mode, the motorized damper (540) is positioned such that air is directed through the ducting system (600) from the outdoor environment to the indoor environment through the side-facing diffusers (530).
